(19) United States
(12) Patent Application Publication
(10) Pub. No.: US 2026/0116483 A1
(43) Pub. Date: Apr. 30, 2026

(54) METHOD OF SEPARATING BONDED ELEMENTS OF A VEHICLE

(71) Applicant: Silverstone Performance Technologies Limited, Towcester Northamptonshire (GB)

(72) Inventor: Claudio SANTONI, Silverstone, Towcester Northamptonshire (GB)

(21) Appl. No.: 19/478,173

(22) PCT Filed: Apr. 26, 2024
(86) PCT No.: PCT/GB2024/051107

§ 371 Date: Oct. 23, 2025

(30) Foreign Application Priority Data
Apr. 26, 2023 (GB) 2306141.9

(51) Int. Cl. B62D 65/00; B60K 1/04; B62D 27/02

(52) U.S. Cl. CPC B62D 65/00; B60K 1/04; B62D 27/026; B60K 2001/0472

(57) ABSTRACT

A vehicle is provided comprising a first element bonded to a second element by at least one adhesive joint; and at least one wire for cutting the at least one adhesive joint, wherein at least a first portion of the wire is joined to the first element or the second element, and wherein a second portion of the wire is accessible for pulling the wire through the at least one adhesive joint to cut the at least one adhesive joint.

### FIELD OF THE INVENTION

The invention relates to vehicles comprising elements bonded together using adhesive and provided with an integrated cutting wire. The invention also relates to methods of manufacture of such vehicles, and to methods of separating bonded elements of a vehicle using an integrated cutting wire.

### BACKGROUND

Mechanical fasteners, such as nuts and bolts, are very commonly used across vehicles for their strength and ease of unfastening for maintenance. However, mechanical fasteners have substantial downsides. For example, where large elements are joined together, this may require many mechanical fasteners that require significant time and effort fastening and unfastening during maintenance. Additionally, mechanical fasteners are often inefficient at transmitting or reacting to loads that are applied perpendicularly to their main axis (i.e. shear loads), meaning the number and sizing of fasteners has to be increased to prevent all possible failure modes including bolt shear failure, joint slip failure, and failures at the edge of the bolt holes. An alternative means of joining elements of a vehicle is by adhesive. However, adhesive is typically seen as a semi-permanent means of joining elements of a vehicle, which is not conducive to maintenance that involves separating the joined elements. Adhesive, however, provides advantages in that it can be scaled up to join larger elements without significantly increasing the time to join the elements. Adhesive may also improve handling of impact loads from different directions. It is therefore desirable to provide a means of benefitting from the advantages of adhesives for joining elements of a vehicle while facilitating maintenance that involves separating the joined elements.

### SUMMARY OF INVENTION

In accordance with a first aspect of the invention, there is provided a vehicle comprising: a first element bonded to a second element by at least one adhesive joint; and at least one wire for cutting the at least one adhesive joint, wherein at least a first portion of the wire is joined to the first element or the second element, and wherein a second portion of the wire is accessible for pulling the wire through the at least one adhesive joint to cut the at least one adhesive joint.

The invention therefore provides elements bonded together by an adhesive joint with an integrated cutting wire that is arranged so that a portion of the wire can be used to pull the wire through the adhesive joint. This greatly simplifies the separation of elements that are joined by an adhesive joint and so facilitates maintenance of the vehicle.

Preferably, the first portion of the wire is anchored to the first element or the second element, such that the second portion of the wire may be pulled through the at least one adhesive joint to cut the at least one adhesive joint while the second portion of the wire is held in place anchored to the first element or the second element. An anchor will typically comprise a mechanical fastener, such as bolt or rivet to anchor the wire in place. Preferably, the first portion of the wire is anchored to the first element or the second element on a first side of the adhesive joint, and wherein the second portion of the wire is arranged on the second side of the adhesive joint.

In some embodiments, the first portion and/or a third portion of the wire is arranged to extend across the adhesive joint from a first side of the adhesive joint to a second side of the adhesive joint. Here, the wire may be joined to the first or second element by the adhesive joint, sometimes in two places. Preferably the first and third portions of the wire are generally at or proximate opposite ends of the wire and/or cross the adhesive joint generally at or proximate opposite ends of the adhesive joint. Crossing the adhesive joint may allow a the second portion of the wire to be accessible from the second side of the adhesive joint for pulling the wire through the at least one adhesive joint.

Preferably, the first portion of the wire is a portion of the wire at or proximate a first end of the wire and the second portion of the wire is a portion of the wire at or proximate the second end of the wire. In particular, it is preferable for the first end of the wire to be anchored to the first or second element, and for the second end to be accessible for pulling the wire through the adhesive joint. Providing that the accessible portion of the wire is generally at the opposite end of the wire to the anchored end allows for the wire to be conveniently retrieved and manipulated to cut the adhesive joint.

Other embodiments further comprise a conduit provided across at least one of said adhesive joints, wherein the first portion of the wire is joined to the first element or the second element at a first side of the conduit, and wherein the wire is arranged to pass through the conduit such that the second portion of the wire is accessible from the second side of the conduit, or wherein the wire is arranged such that the second portion of the wire is accessible through the conduit from the second side of the conduit. For example, the second portion of the wire may be spaced from the conduit along a direction corresponding to the length of the conduit. Preferably the second portion of the wire is a portion of the wire proximate the second end of the wire, e.g. opposite the first portion of the wire. The conduit may be a tube or other hollow passage, for example, made of rubber.

In particularly preferable embodiments, the at least one adhesive joint comprises areas arranged on surfaces at different angles. Where mechanical fasteners may be used, it becomes particularly difficult to allow mechanical fasteners to be secured along different axes, as this would generally require clearance around the secured elements from multiple different directions to fasten and unfasten the mechanical fasteners. An adhesive joint extending across surfaces at different angles can be conveniently cut using the integrated cutting wire, which may bend or be manipulated along different directions to cut a more complex adhesive joint. Where the adhesive joint is elongate, the different areas on surfaces at different angles may be different areas of the adhesive joint along the elongate direction of the joint, or they may be different areas generally perpendicular to the elongate direction of the joint. In other cases, different ones of the adhesive joints may be arranged on surfaces at different angles but nonetheless cut by the same integrated cutting wire.

As indicated above, generally, the at least one adhesive joint is elongate, preferably having a length of at least 30 cm, preferably at least 50 cm, more preferably at least 100 cm, most preferably at least 200 cm. As described above, an advantage of adhesive joints is that they can be conveniently scaled up in size without significantly increasing the time to separate the joined elements. Elongate adhesive joints are also generally easier to cut. Where a plurality of adhesive joints are provided, each adhesive joint may individually be elongate or the adhesive joints together may be elongate, e.g. extending along an elongate track of the adhesive joints. The width of each adhesive joint may be less than 15 cm, preferably less than 10 cm, more preferably less than 5 cm. The thickness of each adhesive joint may be no more than 10 mm, preferably no more than 5 mm, more preferably no more than 3 mm. Preferably, the thickness of each adhesive joint is in the range 0.5 mm to 5 mm, preferably 1 mm to 3 mm.

Where the at least one adhesive joint is elongate, preferably the wire extends along substantially the entire length of the or each elongate adhesive joint. For example, the first portion of the wire may be joined at one end of the least one adhesive joint, and the second portion of the wire may be accessible at an opposing end of the at least one adhesive joint.

Preferably, the at least one adhesive joint substantially surrounds an area within which the first portion of the wire is joined to the first element or the second element. The cutting wire of the present invention is particularly useful for cutting adhesive joints that surround a central area, since the wire may be anchored or otherwise joined within the surrounded area. Examples of such use cases include electronics enclosures, such a battery tray closed by a lid in which an adhesive joint is applied along the periphery of the tray surrounding the tray centre, or a battery pack secured to the frame of a vehicle by an adhesive joint along the periphery of the battery pack. In these use cases, without an integrated cutting wire, it would be difficult to suitably arrange a cutting wire across the adhesive joint into the surrounded centre area without the present integrated cutting wire that is already joined within the surrounded area.

In many embodiments, the adhesive joint may define a path and the wire is arranged to substantially follow the path of the at least one adhesive joint. For example, the adhesive joint may be provided along a path at the interface between the first and second elements, and so to ensure that the wire may cut each part of the path, the wire may be arranged on one side of the adhesive joint to follow the path, e.g. generally in parallel with the path of the adhesive joint. To hold the wire in place as it follows this path, the wire may be joined to the first element or the second element at a plurality of locations as it follows the path of the at least one adhesive joint, wherein preferably the wire is joined to the first element or the second element at each of the plurality of locations by a patch of adhesive.

As indicated above, the invention is particularly useful in cases in which a first side of the adhesive joint is substantially enclosed between the first element and the second element, and wherein the first portion of the wire is joined to the first element or the second element on the first side of the adhesive joint. This allows the first portion of the wire to be anchored or otherwise joined within enclosed housings or other inaccessible regions of the vehicle, but still allows for the adhesive joint to be cut by the present wire arranged across the joint between the inaccessible enclosed region and an external region.

Preferably, at least 60% of a length of the wire, preferably at least 70%, more preferably at least 80%, more preferably at least 90%, most preferably at least 95% of the length of the wire, is provided on a first side of the adhesive joint, wherein preferably the first side of the adhesive joint is substantially enclosed between the first element and the second element. In this way, the majority of the wire may be secured out of the way during normal use and prevented from becoming damaged.

It has been recognised that it is generally helpful to heat the wire before and/or during cutting to allow the wire to better cut through the adhesive. A convenient way of achieving this is to provide that the first end of the wire is joined to the first element or the second element at an electrical connection point, wherein the electrical connection point electrically connects the wire to at least part of a circuit for heating the wire. For example, a metal anchor point may electrically connect the wire to the circuit. In this way, a technician may use the circuit to heat the wire, for example by retrieving the second end of the wire and completing a circuit to resistively heat the wire, before and/or during cutting the adhesive joint.

Preferably, the wire is a metal wire, preferably a nichrome wire, or stainless steel. Metal wires are particularly suitable for cutting adhesive joints and/or heating. While preferable, in alternative embodiments, the wire could be formed of a polymer, for example.

Preferably, the wire comprises an electrical and/or thermal insulator along at least part of a length of the wire. This may facilitate the application of an electric current to heat up the wire without conducting heat or electricity to the first and second elements, or other portions of the vehicle. The electrical and/or thermal insulator may be made of a sufficiently soft material that it may also be cut by the wire once a force is applied by pulling the wire.

Some embodiments further comprise a barrier between at least some of the wire and the adhesive joint, the barrier being arranged to prevent adhesive from the adhesive joint contacting the wire during assembly of the vehicle. Preferably, the barrier is provided between the wire and the adhesive joint along at least 50% of the length of the wire, preferably 60% or 70% or 80% or 90% or 95% of the length of the wire. Preferably, the barrier follows a path of the adhesive joint, between the adhesive joint and the wire. The barrier may be formed of a material, such as a foam, to prevent squeeze out of the adhesive, while itself capable of being cut by the wire as it is pulled through the adhesive joint. The barrier may prevent the wire from becoming completely embedded in the adhesive joint.

The invention is suitable for any elements of a vehicle connected by an adhesive joint. However, the invention finds particular use when joining relatively large parts in such a way that opposing sides of the joint are not both accessible to a technician.

In particular, in some preferable embodiments, the first element is a vehicle frame and the second element is a battery pack. The one or more adhesive joints may be located along a peripheral edge portion of the battery pack. The one or more adhesive joints substantially surround a centre region of the battery pack. The battery pack may comprise one or more peripheral flanges configured to form at least part of an interface with the frame, and the one or more adhesive joints may be located along one or more of said peripheral flanges. In these embodiments, the integrated cutting wire may allow the battery pack to be removed from the vehicle frame for servicing or replacement. The vehicle frame will generally correspond to the so-called body in white (BIW), in which the frame defines at least the cabin of a passenger vehicle. However, the frame could also be a component that will later be assembled into the vehicle body or BIW. For example, the frame may comprise a floor frame, which may define the rocker and/or door sill portions of the vehicle body, which generally define the plane of the floor of the vehicle. The battery pack may thus be mounted within this floor frame before the floor frame is joined up with one or more other frame portions defining the vehicle body or BIW.

In other preferable embodiments, the first element is a housing of a battery pack of the vehicle and the second element is a closure for closing the housing of the battery pack. For example, the first element may be a tray of a battery pack, which may generally comprise a base and a plurality of peripheral walls defining the tray, and the second element may comprise a lid bonded to the tray, for example bonded to the peripheral walls, by the at least one adhesive joint for closing the tray. In these embodiments, the integrated cutting wire may allow the closure of the battery pack to be removed to open the battery pack and allow access to the housing for maintenance of the contents of the battery pack.

In further aspects of the invention, there may be provided a battery pack for an electric vehicle, the battery pack comprising a housing, preferably a tray, and a closure for closing the housing, preferably a lid for closing the tray, the closure being bonded to the housing by at least one adhesive joint, wherein a first portion of the wire is joined to the housing or the closure, and wherein a second portion of the wire is accessible for pulling the wire through the at least one adhesive joint to cut the at least one adhesive joint. This battery pack may be provided with any of the preferable features described above in connection with the first aspect.

In other preferable embodiments of the first aspect of the invention, one of the first and second elements is a panel, wherein preferably the other of the first and second elements is a vehicle frame or second panel. For example, one of the elements may be a sacrificial panel for protecting valuable elements of a structure or vehicle from debris, abrasion, impact, weather, etc. A particularly preferred example is an underbody panel for a automotive vehicle, the underbody panel facing a road in use. This may protect a high voltage battery pack, or other underbody structures, from impact or debris. Advantageously, the integrated cutting wire may be used to remove the underbody panel from the vehicle to replace in case of damage.

In other embodiments, one of the first and second elements is a first body structure part of the vehicle and the other of the first and second elements is a second body structure part of the vehicle. For example, the invention may be used for sections of a vehicle body structure that may require repair/replacement in case of crash, such as crash rails or bumper beams.

While some particularly preferred uses for the first aspect of the invention have been provided above, it will be appreciated that there are many different possible use cases for the invention. For example, the invention may be used for any electrical enclosure that requires robust mechanical retention and/or high IP rating and infrequent access for service, or any mechanical assembly, such as gearbox or transmission housings or electric motor housings. The invention may also be used for screens or other interfaces of a vehicle centre console, for example. Other uses may include see-through surfaces in vehicles or car interior surfaces.

In accordance with a second aspect of the invention, there is provided a method of separating a first element of a vehicle from a second element of a vehicle, wherein the first element is bonded to the second element by at least one adhesive joint and wherein the vehicle comprises at least one wire for cutting the at least one adhesive joint, wherein at least a first portion of the wire is joined to the first element or the second element, the method comprising retrieving a second portion of the wire and pulling the wire through the at least one adhesive joint to cut the at least one adhesive joint. This method corresponds to a method performed on a vehicle according to the first aspect of the invention. All of the preferred features described above may be implemented in this context.

Preferably, the method comprises heating the wire before and/or during pulling the wire through the at least one adhesive joint, wherein preferably heating the wire comprises passing an electric current through the wire. In particularly preferred embodiments, the first end of the wire is joined to the first element or the second element at an electrical connection point, wherein the electrical connection point electrically connects the wire to at least part of a circuit for heating the wire, and wherein heating the wire comprises heating the wire using said at least part of a circuit.

In accordance with a third aspect of the invention, there is provided a method of manufacturing a vehicle comprising: providing a wire for cutting an adhesive joint, and joining at least a first portion of the wire to a first element or a second element of the vehicle; and bonding the first element to the second element using at least one adhesive joint such that a second portion of the wire is accessible for pulling the wire through the at least one adhesive joint to cut the at least one adhesive joint. This corresponds to a method of manufacturing a vehicle according to the first aspect of the invention. All of the preferred features described above may be implemented in this context. It will be appreciated that, since the wire may be joined to the first or second element by the adhesive joint, the steps of the method may be performed simultaneously when the adhesive joint is formed.

### BRIEF DESCRIPTION OF DRAWINGS

The invention will now be described with reference to the accompanying drawings, of which:

FIG. 1 shows a top view of part of a vehicle body including a mounted battery pack;

FIG. 2 shows a schematic cross-section through the vehicle body and battery pack of FIG. 1;

FIG. 3 shows a schematic top view of the battery pack of FIG. 1 with the vehicle body omitted;

FIGS. 4A to 4E show five alternative schematic cross-sections through a vehicle body with a mounted battery pack;

FIG. 5 shows an enlarged detail of a schematic cross-section through a vehicle body with a mounted battery pack;

FIG. 6 shows a schematic top view of a mounted battery pack with the vehicle body omitted;

FIG. 7 shows a schematic top view of a mounted battery pack with the vehicle body omitted;

FIG. 8 is a flow diagram illustrating a method of mounting a battery pack in a vehicle body;

FIG. 9 is a flow diagram illustrating a method of removing a battery pack mounted in a vehicle body;

FIG. 10 is a schematic cross-section through a vehicle body and battery pack according to another embodiment;

FIG. 11A is a schematic cross-section through a batter pack according to another embodiment; and FIG. 11B is an enlarged portion of FIG. 11A;

FIG. 12 is a schematic top view of the embodiment of FIG. 11A;

FIG. 13 is a schematic top view of a variant of the embodiment of FIG. 11A; and FIG. 14 is a schematic top view of another variant of the embodiment of FIG. 11A.

### DETAILED DESCRIPTION

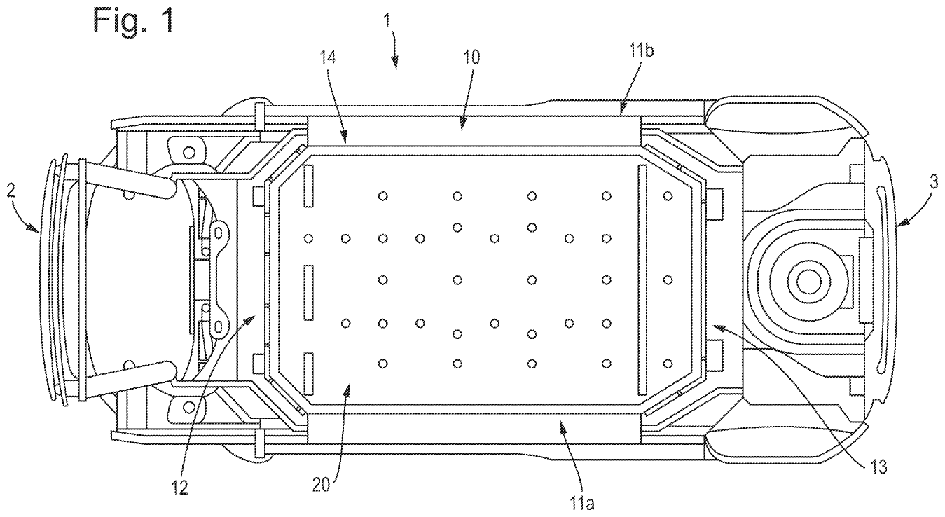

FIG. 1 shows part of a vehicle body 1. The vehicle body comprise a frame 10. This frame could be the so-called body in white (BIW). In FIG. 1, a floor frame section is shown, which comprises opposing longitudinal structural members 11a, 11b, which correspond to the rockers or door sill regions of the vehicle body. This floor frame could be part of the BIW, or could be a separate frame part that is to later be assembled into the BIW. The longitudinal structural members 11a, 11b extend along the longitudinal length of the cabin of the vehicle, between the front and rear wheels, and typically include crash absorbing structured designed to absorb side impact crashes. The frame 10 also includes a front transverse structural member 12 that extends between the longitudinal structural members 11a, 11b just behind the front wheel area of the body, and a rear transverse structural member 13 that extends between the longitudinal structural members 11a, 11b just ahead of the rear wheel area of the body. The transverse and longitudinal structural members thus delimit a floor portion of the vehicle body. The floor portion of the vehicle body generally defines a plane of the floor, which is substantially parallel to the ground. The transverse and longitudinal structural members also define a generally rectangular-shaped opening with truncated corners 14 through the floor portion in the vertical direction, in which the battery pack 20 is located. The front transverse structural member 12 is coupled to a front crash structure 2 and is designed to transmit front impact forces along the longitudinal structural members 11a, 11b and around the battery pack 20. Likewise, the rear transverse structural member 13 is coupled to a rear crash structure 3 and is designed to transmit rear impact forces along the longitudinal structural members 11a, 11b and around the battery pack 20.

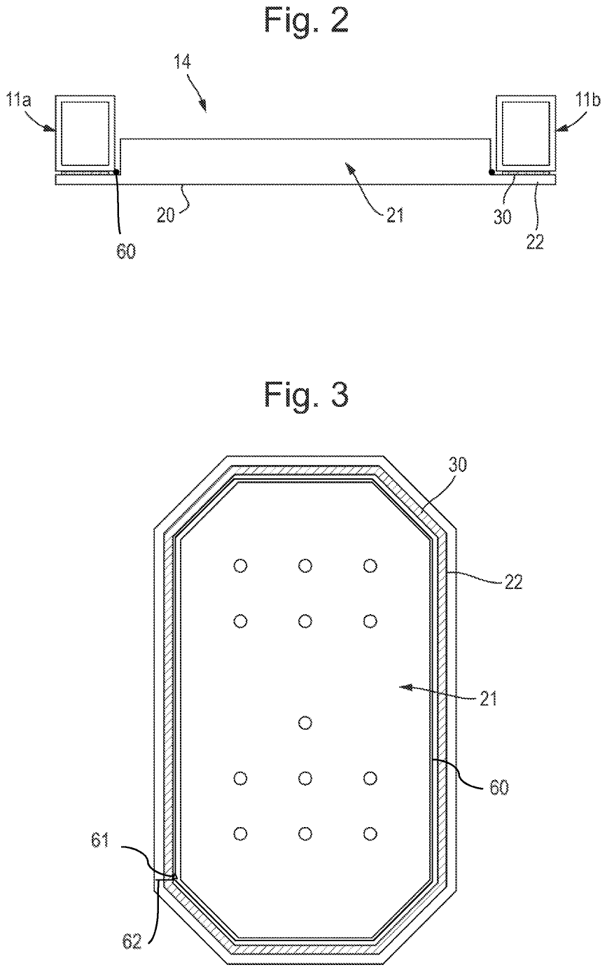

As mentioned above, the battery pack 20 is located in the opening 14 through the frame 10. The battery pack comprises a main housing 21 in which a plurality of battery modules is located, along with other battery components. The battery pack 20 generally corresponds in shape to the shape of the opening 14 through the frame 10. The battery pack is generally planar, having a width in the transverse direction that is similar in dimension to the width of the frame, and a length in the longitudinal direction that is similar in dimension to the length of the frame, but is relatively small in the vertical direction, being intended to sit substantially within the floor of the vehicle. At the peripheral edge of the battery pack 20, surrounding the main housing 21, is a peripheral flange 22. In this embodiment, the battery pack is to be inserted into the frame from beneath the frame, and so the flange 22 extends out from the lower face of the battery pack away from a central axis of the battery pack that is perpendicular to the general plane of the battery pack. The flange has a smaller thickness in the vertical direction than the main housing 21 of the battery pack. Therefore, when inserted from below the frame 10, the peripheral flange 22 may engage the transverse and longitudinal structural members, 11a, 11b, 12, 13, along respective sides of the battery pack 20, while much of the main housing 21 sits inside the opening 14, substantially between the transverse and longitudinal structural members, 11a, 11b, 12, 13. FIG. 2 shows a cross-section through the frame in a plane extending along the vertical and transverse directions, and shows the main housing of the battery being located between the longitudinal structural members, 11a, 11b, with the upper face of the flange 22 and the vertical side walls of the housing 21 forming an interface with the frame 10.

The battery pack 20 in this embodiment is mounted within the frame 10 using an adhesive joint 30, which is shown in FIGS. 2 and 3. As can be seen in FIG. 2, the adhesive joint is positioned on the upper surface of the peripheral flange 22 of the battery pack and bonds the peripheral flange to lower faces of the lateral structural members 11a, 11b. The lower faces of the transverse and longitudinal structural members 11a, 11b, 12, 13 define as a complementary rim about the opening 14 that engages with the peripheral flange. While this interface between the upper surface of the flange 22 and the lower surface of the transverse and longitudinal structural members 11a, 11b, 12, 13 is shown as flat surfaces, it will be appreciated that any complementary interfaces may be used.

FIG. 3 shows a top view of the battery pack 20, with the frame 10 omitted, so that the path followed by the adhesive joint 30 can be seen. As shown in FIG. 3, the main housing of the battery pack has a footprint that is generally rectangular, with truncated corners, to match the shape of the opening 14 through the frame. Around the entire periphery of this main housing 21, the peripheral flange 22 extends from the lower surface of the battery pack, so that there is a step down from the upper surface of the battery pack to the upper surface of the peripheral flange 22. The adhesive joint 30 is provided in one continuous path that extends around the entire peripheral flange 22 of the battery pack 20 so as to surround the main housing 21. This enables the battery pack to be bonded to the frame 10 about the entire periphery of the battery pack.

The adhesive used for the adhesive joint 30 may be a ductile structural adhesive with polyurethane chemistry. The material of the battery case housing 21 and the flange 22 may be a composite material comprising a resin matrix, reinforcement fibres and metallic inserts. The frame 10 may be made of an assembly of aluminium alloys. While these materials are typical, in principle, any combinations of materials for the battery pack and frame may be used with an adhesive suitable for bonding those materials.

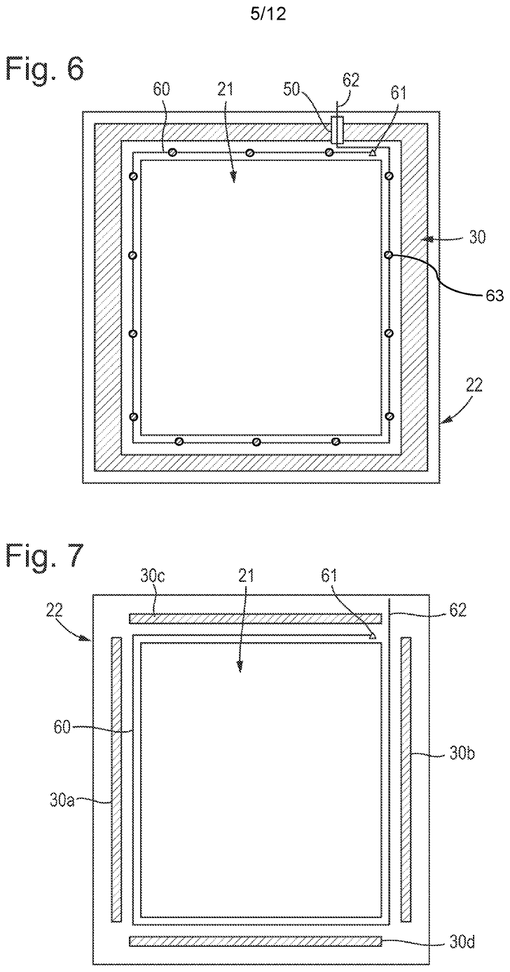

FIGS. 2 and 3 also show that the vehicle has been provided with an integrated cutting wire 60 for cutting the adhesive joint. In this embodiment, an integral cutting wire 60 is provided on the battery pack. This wire may be made of stainless steel and may be 1 mm in diameter, for example. The wire could have a circular cross-section or a square or rectangular cross-section to define sharper cutting edges. Alternatively, the wire could be a braided cutting wire. Most of the length of the wire extends along the peripheral flange 22, positioned between the main housing 21 and the adhesive joint 30. The wire may be weakly adhered to the flange 22 by small dots of adhesive. A clearer example of this is provided in FIG. 6, described below. A first end 61 of the cutting wire 60 is fixedly anchored to the battery pack. In this embodiment, the first end is anchored next to the lower left corner of the main housing 21, as shown in FIG. 6. The cutting wire follows a path, clockwise in FIG. 3, extending completely around the main housing 21. When the wire reaches the anchor point again, the second end 62 of the wire passes across the adhesive joint 30 to be accessible by a technician. In order to cut the adhesive, a technician need only retrieve the second end of the wire 62 and pull the wire through the adhesive joint, following the path of the adhesive joint around the battery pack 20.

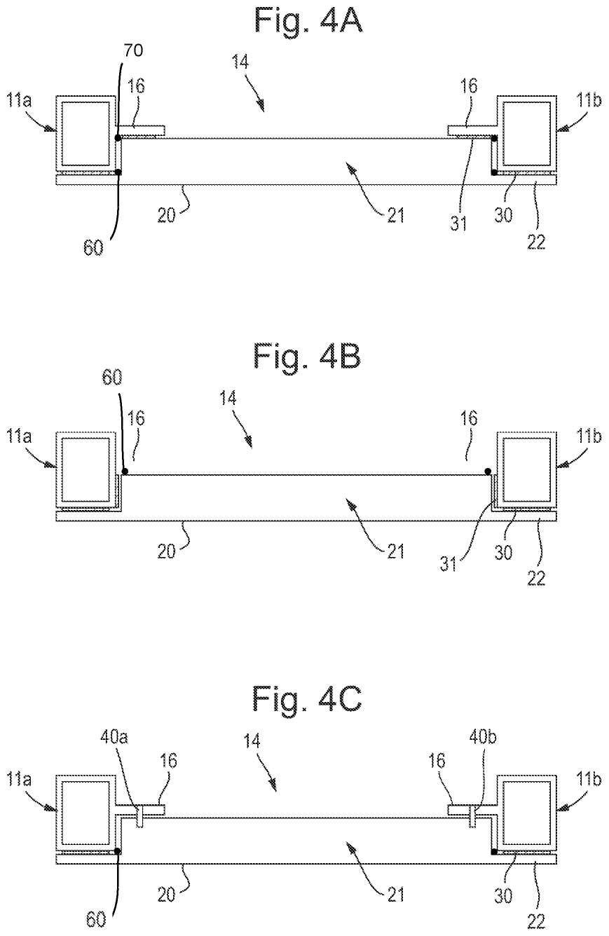

FIGS. 1 to 3 illustrate one possible interface and mounting arrangement for the battery pack 20 and frame 10, but various other mounting arrangements are possible. Some alternative configurations will now be described with reference to FIGS. 4A to 4E, each of which is an alternative cross-section through the frame 10 in a plane extending along the vertical and transverse directions. Each of these may also be provided with an integrated cutting wire, as will be described. The differences between these alternative embodiments and that of FIGS. 1 to 3 will now be described.

FIG. 4A shows an embodiment in which the frame 10 is further provided with a flange 16 that projects from the side walls of the transverse and longitudinal structural members 11a, 11b, 12, 13 partially into the opening 14 for engaging an upper surface of the main housing 21 of the battery pack 20. This defines a substantially stepped interface between the battery pack 20 and the frame 10. The battery pack is additionally bonded to the frame 20 by a second adhesive joint 31 that is positioned between the lower surface of the flange 16 of the frame 10 and the upper surface of the main housing 21 of the battery pack. This second adhesive joint may be provided to extend around the entire periphery of the upper surface of the main housing 21 or may only extend partially around the periphery. This second adhesive joint increases the strength of the bond between the battery pack 20 and the frame 10. In this embodiment, a first cutting wire 60 is provided for cutting the first adhesive joint, provided between the battery pack flange 22 and the lower surfaces of the structural members 11a, 11b, and a second cutting wire 70 is provided for cutting the second adhesive joint 31, provided between the flange 16 of the frame 10 and the upper surface of the main housing 21 of the battery pack. The first cutting wire 60 is anchored to the battery pack flange 22 and extends around the main housing 21 of the battery pack in the same way as described with respect to FIG. 3 so as to be in substantially the same plane of the adhesive joint 30. The second cutting wire 70 may be anchored to the upper surface of the main housing 21 of the battery pack and extend around the main housing 21 in the same plane as the second adhesive joint 31. Removal of this battery pack may therefore involve retrieving the second end of the first cutting wire 60 and pulling this through the first adhesive joint 30, following the path of the adhesive joint around the frame from the outside of the vehicle, before retrieving the second end, i.e. the non-anchored end, of the second cutting wire 70 through the opening 14 through the floor of the frame and pulling this through the second adhesive joint 31, following the path of the adhesive joint around the frame from the inside of the vehicle.

FIG. 4B shows an embodiment in which the interface between the frame 10 and the battery pack 20 is the same as that of FIGS. 1 to 3. However, in this embodiment, a second adhesive joint 31 is provided between the vertical side wall of the main housing 21 of the battery pack 20 and the inner side walls of the transverse and longitudinal structural members 11a, 11b, 12, 13, which face into the opening 14. Not only does this second adhesive joint increase the strength of the bond between the battery pack 20 and the frame 10, but arranging two adhesive joints on surfaces that define an angle to one another ensures that the adhesive joints will experience the same force in different relative directions. For example, a side impact force may produce a shear force on the first adhesive joint 30, but a compressive force on the second adhesive joint 31. This decreases the risk that both adhesive joints would fail as a result of the same impact. In this embodiment, the cutting wire is anchored to the upper surface of the main housing 21 of the battery pack and extends around the perimeter of the upper surface of the main housing 21. The second end of the cutting wire may then be arranged to pass through both the first and second adhesive joints, between the sidewall of the main housing 21 and one of the structural members 11a, 11b and then between the upper surface of the flange 22 of the battery pack and the lower surface of said structural member. To remove the battery pack, a technician may then retrieve the second end of the cutting wire and pull the cutting wire through both adhesive joints, following the path of the adhesive joints around the battery pack 20.

FIG. 4C shows an embodiment in which the interface between the battery pack 20 and the frame 10 is the same as that described with reference to FIG. 4A, with a flange 16 that projects from the side walls of the transverse and longitudinal structural members 11a, 11b, 12, 13 partially into the opening 14. However, in this embodiment, there is no adhesive joint provided along the interface between the flange 16 and the upper face of the main housing 21 of the battery pack. Instead, the interface between the flange 16 and the upper face of the main housing 21 is provided with a number of mechanical fasteners 40a, 40b. Only two mechanical fasteners are shown in the cross-section of FIG. 4C, but it will be appreciated that mechanical fasteners may be provided in a number of places around the interface between the battery pack 20 and the frame 10. In this embodiment, the mechanical fasteners comprise bolts. Threaded bolt shafts are provided that project out of the upper face of the main housing 21 of the battery pack. These bolt shafts are received in corresponding holes through the flange 16 and are secured with nuts so that the battery pack is bolted to the frame. While bolts are described as the mechanical fasteners in this embodiment, it will be appreciated that any type of mechanical fastener may be used, including clips, pins or rivets, among others. In this embodiment, the use of mechanical fasteners 40a, 40b in addition to the adhesive joint 30 between the flange 22 of the battery pack 20 and the frame ensures that the battery mount is more resilient to the different failure modes affecting each joint type individually. Mechanical fasteners may also be useful for seating the battery pack and holding the battery pack in place while the adhesive dries. In this embodiment, the cutting wire 60 may again be anchored to the battery pack flange 22 and extend around the main housing 21 of the battery pack in the same way as described with respect to FIG. 3 so as to be in substantially the same plane of the adhesive joint 30. In this embodiment, separating the battery pack from the frame will require both cutting the adhesive joint using the cutting wire and unfastening the mechanical fasteners 40a and 40b. However, due to the provision of the adhesive joint, fewer mechanical fasteners may be used than would otherwise be necessary to withstand the same impact forces.

FIG. 4D shows an embodiment in which a substantially continuous floor surface 15 extends between the transverse and longitudinal structural members 11a, 11b, 12, 13 so that there is no opening through the frame in the vertical direction. In this embodiment, the battery pack is mounted to the frame by an adhesive joint 30 that is again provided in one continuous path that extends around the entire peripheral flange 22 of the battery pack 20 so as to surround the main housing 21. Additionally, mechanical fasteners 40a, 40b are again provided in the form of bolts, with the threaded bolt shafts being provided to project out of the upper face of the main housing 21 of the battery pack, but in this embodiment being received in corresponding holes through the substantially continuous floor surface 15. The cutting wire of this embodiment may be provided in the same manner described above, and separation of the battery pack from the frame may be the same as for FIG. 4C.

FIG. 4E shows an embodiment that differs from that of FIG. 4D in that the interface between the battery pack and the frame along which the adhesive joint is provided includes portions arranged at an oblique angle relative to the horizontal plane. In particular, instead of the peripheral flange 22 extending in the horizontal plane, in this embodiment, a flange 22a is provided at an angle that slopes down in the direction away from the main housing 21 of the battery pack. As shown in FIG. 4E, this means that the angle that the flange makes to the horizontal (i.e. the plane of the floor and the battery pack) on the left side of FIG. 4E is one rotated anticlockwise by about 10°, and on the right side of FIG. 4E is one rotated clockwise by about 10°. While not shown in this Figure, the flange along the front and rear edges of the battery pack 20 is similarly sloped down and way from the main housing 21 of the battery pack. The lower face of the transverse and longitudinal structural members 11a, 11b, 12, 13 is inclined in a complementary manner, i.e. sloping downward in the direction away from the centre of the frame. The adhesive joint 30 is provided between the inclined upper surface of the flange 22a and the inclined lower surface of the transverse and longitudinal structural members 11a, 11b, 12, 13. This interface shape means that a side impact force will place the adhesive joint partly in compression instead of in pure shear, meaning it is less likely to fail. Again, a cutting wire 60 is provided that is capable of cutting through this angled adhesive joint, being anchored to the angled flange 22a between the adhesive joint 30 and the main housing 21 of the battery pack and following the path of the adhesive joint around the main housing 21.

It will be appreciated that the various features described above with respect to the alternative cross-sections could be combined as desired. For example, the inclined flange 22a of FIG. 4E could be provided in any of the embodiments of FIG. 2 or 4A to 4D. Similarly, the second adhesive joint 31 on the vertical sidewalls in FIG. 4B could be provided in any of the other embodiments.

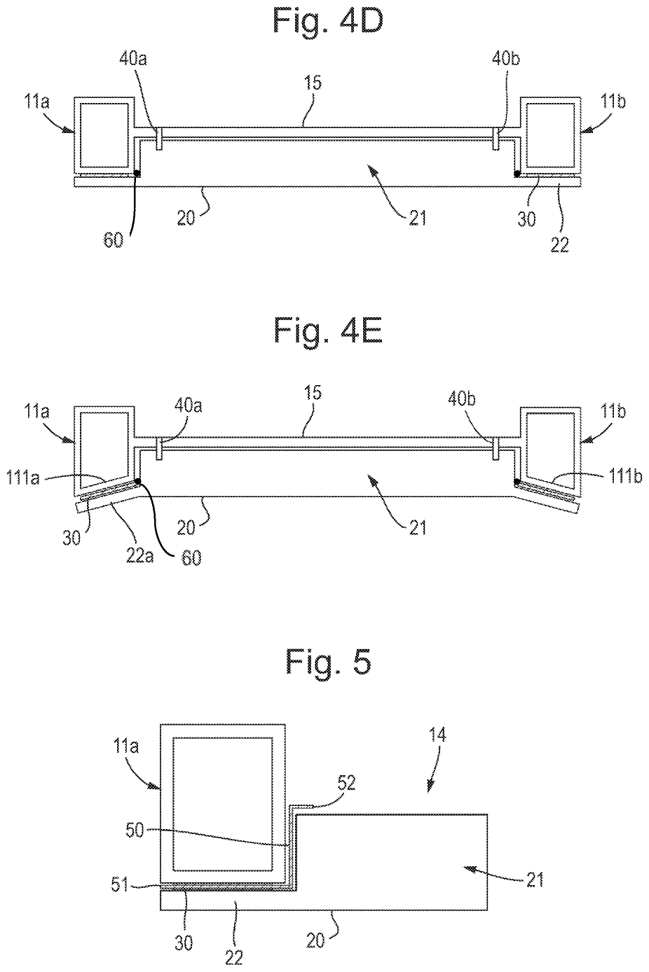

FIG. 5 shows an enlarged portion of a frame and battery pack constructed in substantially the same way as described with reference to FIGS. 1 to 3. However, in this embodiment, a conduit 50 has been provided across the adhesive joint 30. This conduit may be a small tube made of soft and thin rubbery or polymeric material, for example EPDM or ABS, approximately 2 mm in diameter, that extends across the adhesive joint 30. In this embodiment, the conduit follows a path starting at a first end 51, which is located at the very outer edge of the peripheral flange in the opening into the gap between the flange and the lower face of the longitudinal structural member, so as to be accessible from the outside of the frame. The conduit extends from this first end 51 across adhesive joint, towards the centre of the battery pack. The conduit follows the interface between the frame 10 and the battery pack 20 until it reaches the opening through the frame. The second end 52 of the conduit is thus accessible near the upper surface of the main housing 21 of the battery pack 20 through the opening 14 through the frame 10. As will be described in more detail below, this conduit may be used in removing the battery pack from the frame. In particular, the integrated cutting wire may be arranged to pass between the first and second end 51, 52, along the conduit 50. With the wire so arranged, the technician may pull the wire through the adhesive joint, following the path of the adhesive joint around the battery pack 20, to cut the adhesive joint to allow for removal of the battery pack.

FIG. 6 schematically shows a top view of a battery pack to more clearly illustrate the integrated cutting wire 60. This battery pack is substantially square in profile, and again comprises a main housing 21 that holds the battery modules and the like, and a peripheral flange 22 extending therefrom. Once again, an adhesive joint 30 is provided that extends along this peripheral flange 22, surrounding the main housing 21 of the battery pack 20. In this embodiment, an integral cutting wire 60 is provided on the battery pack. Again, this wire may be made of stainless steel and may be 1 mm in diameter, for example, and could have a circular cross-section or a square or rectangular cross-section to define sharper cutting edges. Alternatively, the wire could be a braided cutting wire. Most of the length of the wire extends along the peripheral flange 22, positioned between the main housing 21 and the adhesive joint 30. The wire may be weakly adhered to the flange 22 by small dots of adhesive 63 positioned at a plurality of locations around the path followed by the cutting wire 60. This may be the same adhesive as the adhesive used for the joint 30, or could be a different adhesive. A first end 61 of the cutting wire 60 is fixedly anchored to the battery pack. In this embodiment, the first end is anchored next to the top right corner of the main housing 21, as shown in FIG. 6. This anchor point preferably electrically connects the cutting wire to part of a circuit that may be used to resistively heat the cutting wire. The cutting wire follows a path, anticlockwise in FIG. 6, extending completely around the main housing 21. A short section of the wire overlaps itself after having completed one full path around the main housing 21 and then the second end of the wire 62 passes through a conduit 50 that is provided across the adhesive joint 30. The free second end is thus provided at the outer edge of the battery pack 20, where it may be accessed by a technician. In order to cut the adhesive, a technician need only retrieve the second end of the wire 62, complete the circuit to the second end of the wire in order to resistively heat the wire, and pull the wire through the adhesive joint, following the path of the adhesive joint around the battery pack 20. To complete the circuit a second connection point may be provided elsewhere on the battery housing 21, which electrically connects to the anchor point. In some embodiments, electric current from the battery modules in the battery pack may be used to resistively heat the wire 60.

An alternative embodiment is shown in FIG. 7. This embodiment differs from FIG. 6 in that four separate adhesive joints are provided along respective edges of the battery pack corresponding respectively to the edges of the transverse and longitudinal structural members 11a, 11b, 12, 13. In this embodiment, the second end of the wire 62 may simply be provided through the gap between two adjacent adhesive joints, to allow second end of the wire to be accessible along the outer edge of the battery pack 20.

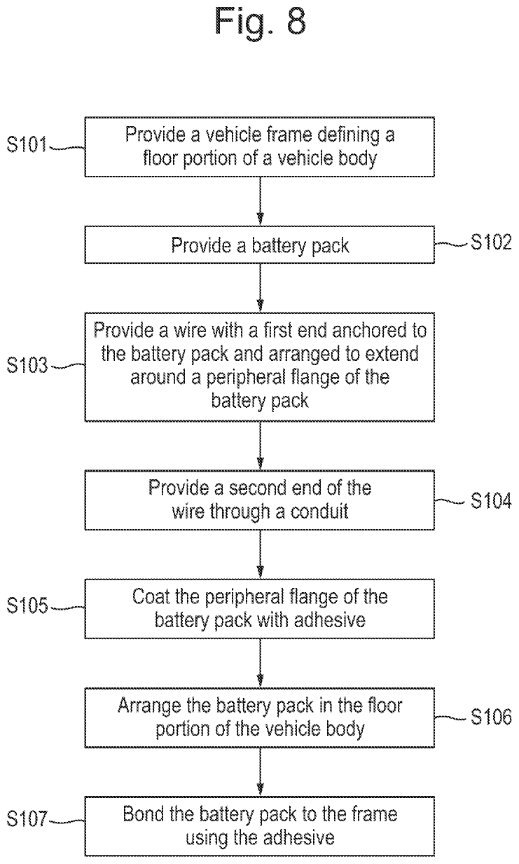

The process for mounting a battery pack in the frame of the vehicle body will now be described with further reference to FIG. 8. In a first step S101, the vehicle frame is provided, which defines the floor portion of the vehicle body, and in step S102, the battery pack to be mounted to the frame is provided. The frame 10 may be any of the frames described above with respect to FIGS. 1 to 4E in particular and the battery pack 20 may be the corresponding battery pack described above.

In step S103, a cutting wire 60 is provided. The cutting wire has its first end 61 anchored to the battery pack 20 at a point that will be located within the adhesive joints that are applied in subsequent steps. Any suitable anchoring member may be used for this purpose, such as an eye bolt to which the wire is tied. The wire is provided so as to extend around the periphery of the battery pack, following a path that will be slightly inside the path of the adhesive joints that are applied in subsequent steps until the wire has extended substantially around the full perimeter of the battery pack 20. As mentioned above, to hold the wire in place on battery pack 20, small dots of adhesive may be applied at regular intervals along the path of the wire.

In step S104 a conduit 50 is provided and arranged near the second end 62 of the wire and arranged so that it will extend across the adhesive joints that are applied in subsequent steps. The second end of the wire 62 is then passed through the conduit 50.

In step S105, an adhesive is applied to coat the peripheral flange 22 of the battery pack 20. As described above, this adhesive is preferably a paste-like, ductile structural adhesive with polyurethane chemistry and is applied by coating the peripheral flange 22 of the battery pack 20 while the peripheral flange is horizontal and facing upwards. The adhesive is applied with a thickness of at least 3 mm, which will compensate for any roughness in the surface of either the battery pack or the frame. The adhesive is applied to define the one or more adhesive joints 30, typically extending around the entire periphery of the battery pack to surround the main housing 21 of the battery pack. The adhesive is applied so that it extends over the conduit provided in step S104, such that the second end of the wire may nonetheless be accessed and move freely in the conduit 50.

In step S106, the battery pack 20 is arranged in position in the floor portion defined by the frame 10. The battery pack is arranged so that the adhesive on the battery pack is located at the appropriate interface with the frame 10, as described above. In this step, any mechanical fasteners 40a, 40b may be used to correctly position the battery pack 20 in place and so could include means to guide and locate the battery pack into its exact location within the vehicle frame during the arranging step. For example, if the mechanical fasteners include bolts, then the bolt shaft and complementary bolt holes may assist in positioning the frame and battery pack. A similar effect can be achieved without mechanical fasteners using dowel pins or the like.

Finally, in step S107, the battery pack is bonded to the frame using the adhesive joints. This process may involve pressing the battery pack against the frame while the adhesive sets. This may simply involve lowering the frame onto the battery pack or else by pressing the battery pack up into the frame so that the weight of the frame works to press the battery pack against the frame and counteract the hydraulic force generated by the adhesive squeeze out. However, preferably mechanical fasteners 40a, 40b are used, which may be used to clamp the battery pack against the frame, while the adhesive sets to bond the battery pack to the frame. These mechanical fasteners between the battery pack and the vehicle frame may clamp the two together during the bonding in order to counteract the hydraulic force generated by the adhesive squeeze out. Such mechanical fasteners could be driven to hard stop through compression limiters so as to control the adhesive gap to an exact dimension and avoid hard contact between the vehicle frame and the battery case. For example, where the mechanical fasteners include bolts, a 3 mm spacing element may be placed on one or more of the bolt shafts between the battery pack and the frame to ensure an adhesive joint thickness of 3 mm. The mechanical fasteners could also exclusively provide the means to hold the battery pack in place whilst the adhesive rigidifies, thus enabling subsequent vehicle handling operations whilst the adhesive achieves its full strength.

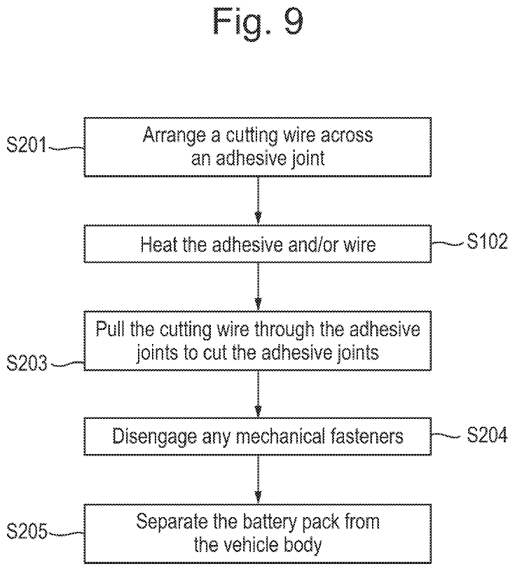

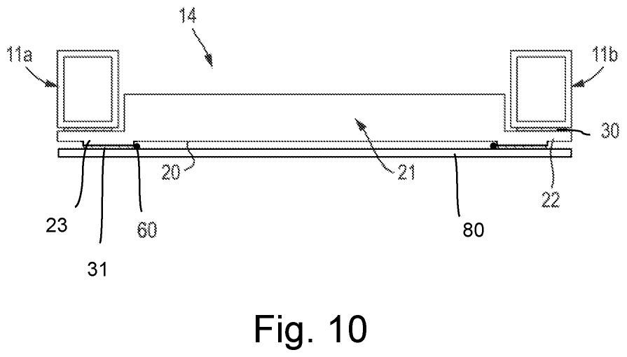

The process of removing a battery pack mounted in the above manner will now be described with further reference to FIG. 9. In a first step, S201, a cutting wire is arranged across an adhesive joint. In the case of an embodiment of the sort shown and described in relation to FIGS. 6 and 7, the cutting wire may be provided prearranged across the adhesive joint.

In step S202, the adhesive and/or the wire may be heated. Heating of the adhesive may soften the adhesive, while heating the wire cause the wire to soften the adhesive as it comes into contact with the adhesive. The adhesive may be heated by placing a heat source in contact with the opposing surface of the peripheral flange. The wire may be heated by a resistive process, as described above. As mentioned above, if the wire is anchored at one end to the battery pack or frame, the anchor point could include an electrical connection to the vehicle ground or to a dedicated circuit of the vehicle that is accessible in the vehicle when the battery is being serviced.

In step S203, the wire is pulled through the adhesive joints. The cutting wire may be pulled so as to follow the adhesive joints along their path about the battery pack. The pulling may be done manually or assisted by tools. If an integral cutting wire is used, only one end of the wire will need to be pulled with the other remaining anchored in place. Once the wire has been pulled through the full path of the adhesive joints, the adhesive will be cut.

In step S204, any mechanical fasteners 40a, 40b may be disengaged. For example, if the battery pack 20 is also bolted to the frame, then the bolts may be removed to allow the battery pack to be extracted.

Finally, in step S205, the battery pack, with the adhesive joints cut and any mechanical fasteners disengaged, is separated from the frame of the vehicle body.

The above embodiments have illustrated embodiments in which the invention is used to provide a means of separating a vehicle battery pack from a vehicle frame. Other embodiments illustrating the invention in other contexts will now be described.

FIG. 10 shows an embodiment in which the invention is implemented in the context of a sacrificial underbody panel of an electric vehicle, although in principle the invention may be used to join a sacrificial underbody panel to other types of vehicle, or to join other types of panels to vehicle frames. In this embodiment, the vehicle comprises a battery pack 20 mounted to a vehicle frame in the same manner as described with respect to FIGS. 1 to 3. In particular, a first adhesive joint 30 is provided joining the battery pack 20 by flanges 22 to the lower face of structural members 11a, 11b of the vehicle frame.

This embodiment differs from that of FIGS. 1 to 3 in that a sacrificial underbody panel 80 is applied over the lower facing surface of the battery pack 20. The underbody panel 80 is a flat sheet of a suitable material such as aluminium or carbon fibre reinforced polymer. The interface between the battery pack 20 and the underbody panel 80 is defined by a raised ridge 23 on the lower face of the battery pack. This ridge 23 is provided generally in the region of the peripheral flange 22 and so extends generally around the periphery of the lower face of the battery pack 20. The underbody panel 80 is bonded to this ridge 23 by a second adhesive joint 31 located between the ridge 23 and the upper-facing surface of the sacrificial underbody panel 80. The purpose of this raised ridge 23 is to space the sacrificial underbody panel 80 from the main housing 21 of the battery pack to improve the operation of the sacrificial underbody panel 80.

A cutting wire 60 is provided in the space between the sacrificial underbody panel 80 and the lower face of the battery pack 20 in the area located surrounded by the second adhesive joint 31. The cutting wire 60 is anchored to the underbody panel 80 at an anchor point in the space between the sacrificial underbody panel 80 and the lower face of the battery pack 20 in the area surrounded by the second adhesive joint 31. As with the previous embodiments, the cutting wire 60 may be arranged to follow the path of the adhesive joint, optionally secured to the underbody panel 80 by dots of adhesive in the same manner described with reference to FIG. 6. Again, having followed the full path of the adhesive joint, a second free end of the wire 60 may be arranged to cross the adhesive joint so as to be accessible to a technician from the edge of the battery pack, between the flange 22 and the underbody panel 80.

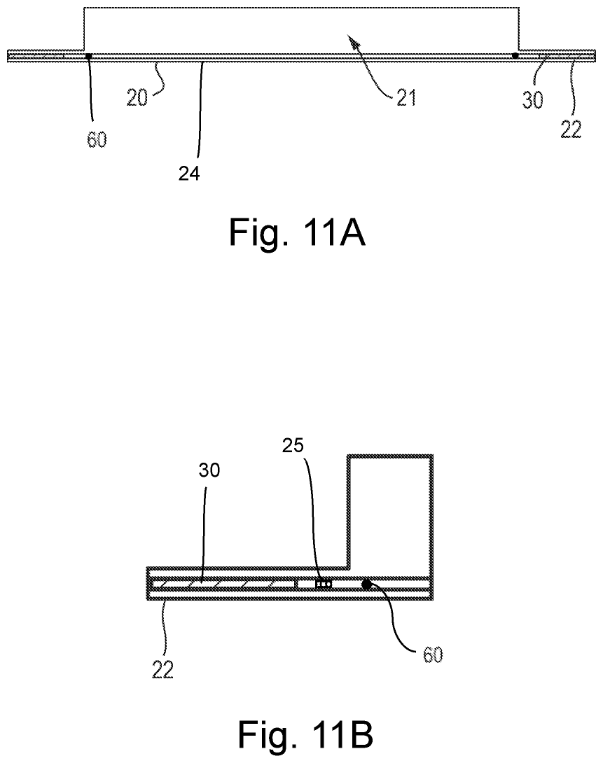

FIG. 11A shows an embodiment in which the first element is a battery pack housing and the second element is a closure 24, i.e. a lid, for the battery pack housing. In this embodiment, the main body 21 and the flange 22 of the battery pack define an open tray, open through the lower surface shown in the Figure. This tray is closed by a lid 24, which has a shape and size that follows the perimeter of the tray defined by the flange. The lid 24 is secured to the tray by an adhesive joint 30 that is provided between the flange and the lid, and which extends around the entire periphery of the battery pack.

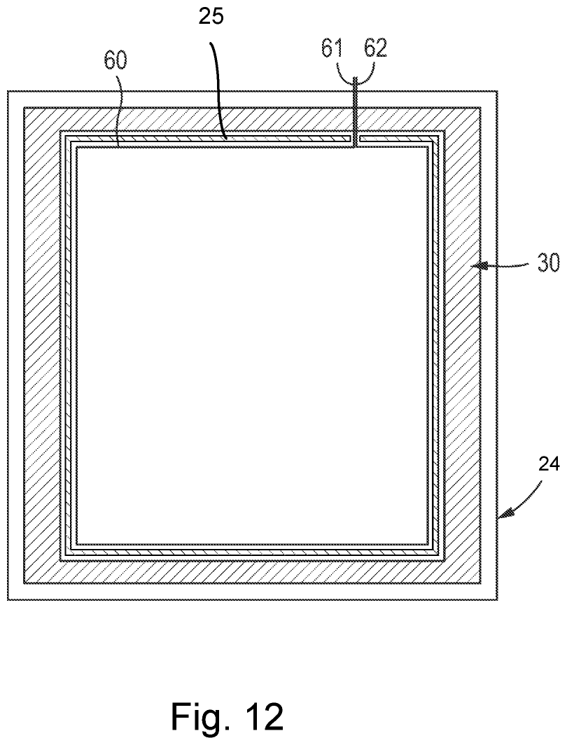

FIG. 12 shows a schematic plan view of the lid 24, showing the arrangement of the adhesive joint 30 and the cutting wire 60. As shown in this Figure, in this embodiment, the adhesive joint 30 extends around the periphery of the battery pack lid 24, surrounding a centre region of the lid. The cutting wire 60 is arranged so that it follows a path of the adhesive joint around the periphery of the lid, offset so as to be parallel to the path of the adhesive joint. Although not shown in this Figure, the cutting wire may be held in place using small dots of adhesive, in the manner described above with reference to FIG. 6. In this embodiment, the first and second ends 61, 62 of the wire are arranged to each extend across the adhesive joint, so that the adhesive joint holds these sections of the wire in place. The first and second ends 61, 62 of the wire are arranged to cross the adhesive joint in substantially the same place on the battery lid 24.

As shown in FIG. 11B, in this embodiment, a barrier 25 is located between the adhesive joint 30 and the cutting wire 60. This barrier may be an elongate strop formed of a foamed material, for example. FIG. 12 shows that the barrier 25 is arranged between the wire 60 and the adhesive joint 30 and follows the paths of the wire 60 and the adhesive joint 30 as they extend around the periphery of the battery lid 24. A small gap is provided in the barrier 25 for the wire to pass through where the first and second ends 61, 62 of the cutting wire 60 extend across the adhesive joint 30. It will be appreciated that a barrier of this sort may be used in any of the preceding embodiments to protect the wire from adhesive squeeze out during formation of the adhesive joint 30.

In order to remove the battery lid 24 from the tray in this embodiment, the technician may retrieve the first and second ends 61, 62 of the wire 60. One end may then be anchored in place, while the other end is pulled around the path of the adhesive joint, through the adhesive joint to cut through the adhesive. This action of pulling the wire to cut the adhesive joint will also cut the foam used to form the barrier between the adhesive joint 30 and the wire.

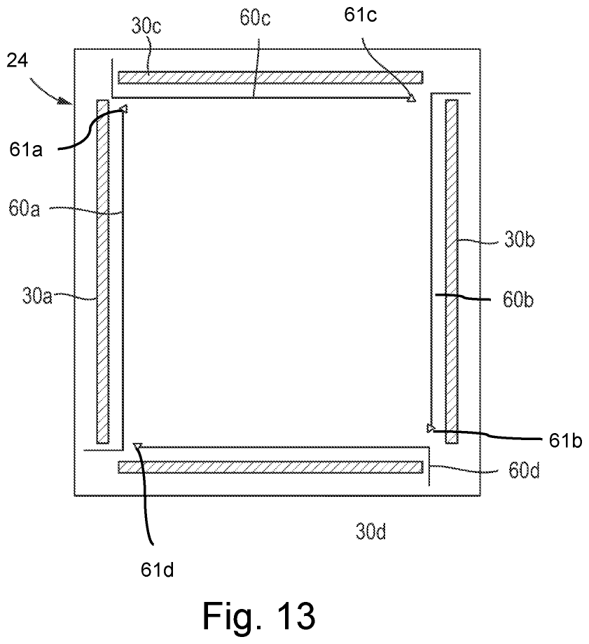

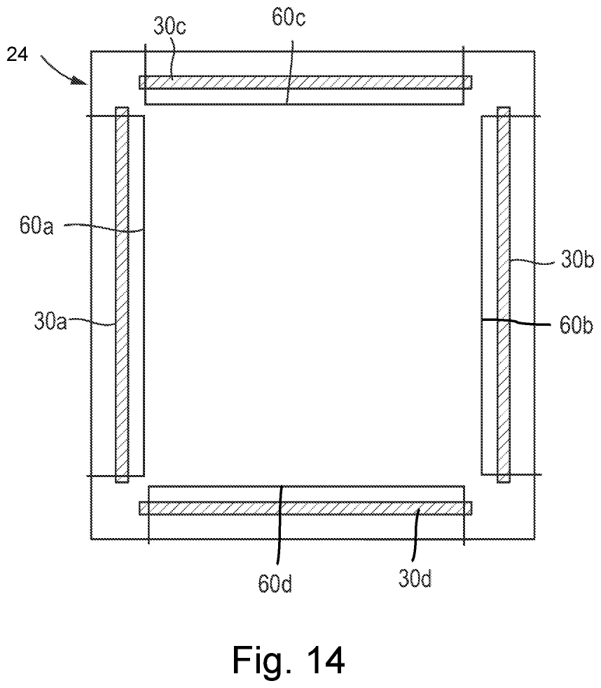

In each of the above embodiments, a single cutting wire has been provided that extends all of the way around the perimeter of the joined elements. However, this is not essential and indeed may not be practical if other parts of the vehicle obstruct part of the periphery of the elements. FIG. 13 shows a variant in which multiple cutting wires are provided. This variant is shown in the context of the battery tray and lid just described, but it will be appreciated that this may apply to any of the above embodiments.

FIG. 13 shows a batter pack lid 25, which generally has a square shape in this schematic depiction. A separate adhesive joint 30a, 30b, 30c, 30d is provided along each peripheral edge of the lid. Together, the adhesive joints substantially surround a centre region of the lid. A respective cutting wire 60a, 60b, 60c, 60d is provided along each edge of the lid, inset from the respective adhesive joint 30a, 30b, 30c, 30d. A first end of each wire 60a, 60b, 60c, 60d is anchored to the lid 24 at a respective anchor point 61a, 61b, 61c, 61d located at one end of the respective adhesive joint 30a, 30b, 30c, 30d. From the anchor point, each wire 60a, 60b, 60c, 60d follows the path of the respective adhesive joint 30a, 30b, 30c, 30d to the opposite end of the adhesive joint. In this embodiment, each wire extends beyond the end of the respective adhesive joint 30a, 30b, 30c, 30d, and then turns and extends towards the edge of the battery pack lid 24 so that the second end of the wire is accessible by a technician. While not shown, again, the wires may be held in place by small dots of adhesive, for example, along the paths of the wires 60a, 60b, 60c, 60d. In this embodiment, a technician may sequentially retrieve the second end of each wire 60a, 60b, 60c, 60d and pull that wire through the respective adhesive joint 30a, 30b, 30c, 30d towards the respective anchor point 61a, 61b, 61c, 61d to cut the adhesive joint.

In another variant, shown in FIG. 14, the first and second ends of each wire may cross over the respective adhesive joint 30a, 30b, 30c, 30d generally at opposing ends of the respective adhesive joint 30a, 30b, 30c, 30d, and a technician may retrieve the opposing ends of each wire and pull them towards each other to cut the adhesive joint.

1. A vehicle comprising:
a first element bonded to a second element by at least one adhesive joint; and
at least one wire for cutting the at least one adhesive joint, wherein at least a first portion of the wire is joined to the first element or the second element, and wherein a second portion of the wire is accessible for pulling the wire through the at least one adhesive joint to cut the at least one adhesive joint.

2. A vehicle according to claim 1, wherein the first portion of the wire is anchored to the first element or the second element, such that the second portion of the wire may be pulled through the at least one adhesive joint to cut the at least one adhesive joint while the second portion of the wire is held in place anchored to the first element or the second element.

3. A vehicle according to claim 2, wherein the first portion of the wire is anchored to the first element or the second element on a first side of the adhesive joint, and wherein the second portion of the wire is arranged on the second side of the adhesive joint.

4. A vehicle according to claim 1, wherein the first portion and/or a third portion of the wire is arranged to extend across the adhesive joint from a first side of the adhesive joint to a second side of the adhesive joint.

5. A vehicle according to claim 1, wherein the first portion of the wire is a portion of the wire at or proximate a first end of the wire and the second portion of the wire is a portion of the wire at or proximate a second end of the wire.

6. A vehicle according to claim 1, further comprising a conduit provided across at least one of said adhesive joints, wherein the first portion of the wire is joined to the first element or the second element at a first side of the conduit, and wherein the wire is arranged to pass through the conduit such that the second portion of the wire is accessible from the second side of the conduit, or wherein the wire is arranged such that the second portion of the wire is accessible through the conduit from the second side of the conduit.

7. A vehicle according to claim 1, wherein the at least one adhesive joint comprises areas arranged on surfaces at different angles.

8. A vehicle according to claim 1, wherein the at least one adhesive joint is elongate, having a length of at least 30 cm.

9. (canceled)

10. A vehicle according to claim 1, wherein the at least one adhesive joint substantially surrounds an area within which the first portion of the wire is joined to the first element or the second element.

11. A vehicle according to claim 1, wherein the wire is arranged to substantially follow a path of the at least one adhesive joint.

12. A vehicle according to claim 11, wherein the wire is joined to the first element or the second element at a plurality of locations as it follows the path of the at least one adhesive joint.

13. A vehicle according to claim 12, wherein the wire is joined to the first element or the second element at each of the plurality of locations by a patch of adhesive.

14. A vehicle according to claim 1, wherein a first side of the adhesive joint is substantially enclosed between the first element and the second element, and wherein the first portion of the wire is joined to the first element or the second element on the first side of the adhesive joint.

15. A vehicle according to claim 1, wherein at least 60% of a length of the wire provided on a first side of the adhesive joint.

16. A vehicle according to claim 1, wherein the first portion of the wire is joined to the first element or the second element at an electrical connection point, wherein the electrical connection point electrically connects the wire to at least part of a circuit for heating the wire.

17. (canceled)

18. (canceled)

19. A vehicle according to claim 1, further comprising a barrier between at least some of the wire and the adhesive joint, the barrier being arranged to prevent adhesive from the adhesive joint contacting the wire during assembly of the vehicle.

20. A vehicle according to claim 1, wherein the first element is a vehicle frame and wherein the second element is a battery pack.

21. A vehicle according to claim 1, wherein the first element is a housing of a battery pack of the vehicle and wherein the second element is a closure for closing the housing of the battery pack.

22. (canceled)

23. (canceled)

24. A method of separating a first element of a vehicle from a second element of a vehicle, wherein the first element is bonded to the second element by at least one adhesive joint and wherein the vehicle comprises at least one wire for cutting the at least one adhesive joint, wherein at least a first portion of the wire is joined to the first element or the second element, the method comprising retrieving a second portion of the wire and pulling the wire through the at least one adhesive joint to cut the at least one adhesive joint.

25. (canceled)

26. (canceled)

27. A method of manufacturing a vehicle comprising:
providing a wire for cutting an adhesive joint, and joining at least a first portion of the wire to a first element or a second element of the vehicle; and
bonding the first element to the second element using at least one adhesive joint such that a second portion of the wire is accessible for pulling the wire through the at least one adhesive joint to cut the at least one adhesive joint.
